(19) United States
(12) Patent Application Publication
(10) Pub. No.: US 2003/0019509 A1
(43) Pub. Date: Jan. 30, 2003

(54) Mobile self-contained vehicle wash

(76) Inventors: Randy J. Locascio, Port Chester, NY (US); John G. Hubbard, Harrison, NY (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 09/915,242

(22) Filed: Jul. 25, 2001

(51) Int. Cl. B08B 3/02

(52) U.S. Cl. 134/10; 134/111; 134/26; 134/34

(57) ABSTRACT

This invention relates to an apparatus and method of construction of the apparatus where the apparatus is a portable self-contained structure used for cleaning motor vehicles. The apparatus is completely self-sufficient with an ability to: carry environmentally safe cleaning products; to supply the water needed for vehicle washing; and to provide the power needed for vehicle washing, vacuuming, and other equipment associated with the apparatus.

### BACKGROUND OF THE INVENTION

1. Field of the Invention

This invention relates to an apparatus, a method of construction of the apparatus and a method of use of the apparatus where the apparatus is a portable self-contained vehicle wash. The vehicle wash apparatus is completely self-sufficient with an ability to: carry environmentally safe cleaning products used in vehicle washing; to supply the water needed for vehicle washing; to provide the power needed for vehicle washing, vacuuming, and other equipment associated with the vehicle wash apparatus; and to dispose of or to recycle in an environmentally safe manner any by-products of vehicle washing.

2. Brief Description of the Prior Art

Car washes are commonly represented as a building where a vehicle enters one end of the building; attaches to a moving track; and then exits the other end of the building as a cleaned and/or waxed vehicle. This method of cleaning vehicles can be time consuming and costly. Costs can be especially high when vehicles require movement from such multi-car locations as storage areas, shopping mall parking lots or vehicle dealerships. Cleaning vehicles can be time consuming when an individual is either at work or at another activity and needs to allot time to bring a car to a car-wash facility.

To respond to this situation, individual companies have been started to clean vehicles off-site without the need for a fixed structure wash. However, these off-site ventures lack most of the cleaning and waxing devices of a fixed structure vehicle wash. Also, off-site cleaning still requires disposal of waste water which can be harmful or toxic to the surrounding environment. Off-site waste water disposal and/or recycling as well as independent off-site electrical supply can be difficult to obtain.

It is seen from the foregoing that there is a need for an apparatus which overcomes the disadvantages found in the prior art concerning off-site vehicle washing, specifically the supply of environmentally safe cleaning supplies and support equipment, independent power for the support equipment, and proper management of waste water runoff from the vehicle wash.

### SUMMARY OF THE INVENTION

It is therefore an object of the present invention to provide a self-contained vehicle wash apparatus.

It is therefore a further object of the present invention to provide a mobile self-contained vehicle wash apparatus.

It is therefore a still further object of the present invention to provide a mobile self-contained vehicle apparatus which can utilize environmentally safe cleaning products.

It is therefore a still further object of the present invention to provide a mobile self-contained vehicle wash apparatus capable of recovery and management of its waste water runoff.

It is therefore a still further object of the present invention to provide a mobile self-contained vehicle wash apparatus equipped to independently power its wash support equipment.

It is therefore a still further object of the present invention to provide a safe and time-sensitive method of assemblage of a mobile self-contained vehicle apparatus.

It is therefore a still further object of the present invention to provide a complete offsite vehicle wash method.

To attain the objects described, there is provided an apparatus contained in a towable trailer. The apparatus has the main component of a disassembled vehicle wash structure that is removed from the trailer and assembled for use as a self-contained vehicle wash. Assembly and disassembly of the vehicle wash structure should each take approximately thirty minutes when accomplished by two operators.

Major support equipment for the vehicle wash structure such as a power generator, a steam and power wash generator, a compressor, and a vacuum are located and operate within a sound and fire protected trailer. Power, pressure wash, compressed air and other support to the vehicle wash structure are provided by way of flex hoses which serve as umbilical trunks to the wash structure. Portable equipment and supplies such as hand-held spray guns, towel dispensers, cleaning products and wash buckets can be removed from the trailer for use within the vehicle wash structure.

Waste-water and all other residual effluence (such as sand, silt, and trace elements of petroleum products) produced by vehicle washing are returned to a high filtration water reclamation system within the trailer. At the end of the cleaning cycle period, the cartridge filters of the water reclamation system can be removed by a licensed waste hauler. During a standard wash day with the vehicle wash apparatus operated by four employees and supervised by one employee, approximately fifty vehicles (at seven minutes per vehicle) can be cleaned. With no water lost to run-off, water is lost only through evaporation with a total daily loss of approximately two gallons.

### BRIEF DESCRIPTION OF THE DRAWINGS

Thus by the present invention its objects and advantages will be realized, the description of which should be taken in conjunction with the drawings wherein:

FIG. 1 is a view from a perspective angle showing the trailer used to transport the vehicle wash apparatus.

FIG. 2 is a sectional view looking to the interior wall of the trailer with wash support equipment shown.

FIG. 3 is an electrical schematic of the vehicle wash apparatus, depicting a power source and various power circuits.

FIG. 4 is a diagram of the compressed air system of the vehicle wash apparatus.

FIG. 5 is a diagram of the water system of the vehicle wash apparatus.

FIG. 6 is a detail of the transition box and flexible hose used to conduit support systems by attachment to the vehicle wash structure.

FIG. 7 is a sectional view from the rear of the trailer looking to the forward end of the trailer to show the support equipment manifold and flexible line connection to the umbilical trunk and access port.

FIG. 8 is a sectional view from the mid-point of the trailer looking to the forward end of the trailer with the wash support equipment shown.

FIG. 9 is a sectional view from the rear of the trailer looking to the forward end of the trailer with the stowage of containment cart and removal ramps shown.

FIG. 10 is a side view of a loaded containment cart resting on removal ramps.

FIG. 11 is a plan view of an unloaded containment cart.

FIG. 12 is a detail view of an upright vehicle wash structure cornerpiece.

FIG. 13 is a plan view of the placement of the vehicle wash structure containment mat.

FIG. 14 depicts the aluminum structural components of the vehicle wash apparatus positioned for assembly.

FIG. 15 is a side view depicting placement of the bottom and top cords on the containment mat.

FIG. 16 is a plan view of the spray piping layout and canvass roof attachment points of the vehicle wash structure.

FIG. 17 is a side view detailing the assembly of the jack.

FIG. 18 is an end view of the vehicle wash structure showing the jack in operation.

FIG. 19 is a side view of the vehicle wash structure showing placement of the leg posts.

FIG. 20 is a side view of the vehicle wash structure showing placement of the corner pieces and canvass.

FIG. 21 is a side view of the vehicle wash structure showing attachment of the utility hose and placement of the sump filter and pump.

FIG. 22 is a diagram of the waste water treatment system of the vehicle wash apparatus.

### DETAILED DESCRIPTION OF THE PREFERRED EMBODIMENTS

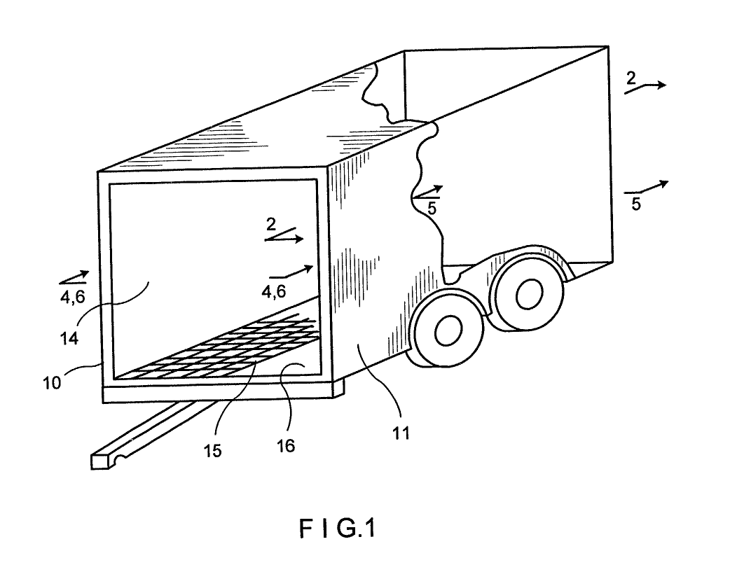

Referring now to the drawings wherein like numerals refer to like elements throughout the several views, one sees that FIG. 1 is a perspective view of trailer 10 which is used for transport of the vehicle wash apparatus. Shaded portion 11 indicates the exterior section of trailer 10. The wash support equipment and trailer doors are not shown and a cutaway view at the front portion of the trailer is shown in order to provide clarity as to the locations of the section views (marked by directional arrows). Section views are numbered to correspond to subsequent numbered figures.

A typical trailer for this use should be rated to carry at least 10,000 pounds; however, the actual weight of the vehicle wash apparatus with trailer 10 loaded would be 7900 pounds. The volumetric area of the interior of the trailer should be 525 cubic feet. Suitable alternatives for weight capacity and size may be used.

Except for the trailer floor, the trailer is lined with light reflective sound suppression insulation 14 which limits the operating volume heard outside trailer 10 to approximately 30 decibels. The reflective feature of insulation 14 enhances lighting conditions in trailer 10, permitting safer and easier use of wash support equipment.

Water-collecting rubber matting 15 rests on a segment of trailer floor 16 where a containment cart would be stored when the vehicle wash apparatus is not being used. Rubber matting 15 isolates from the wash support equipment any residual liquid dripping from the cart as well as providing stable underfooting for any operations within trailer 10.

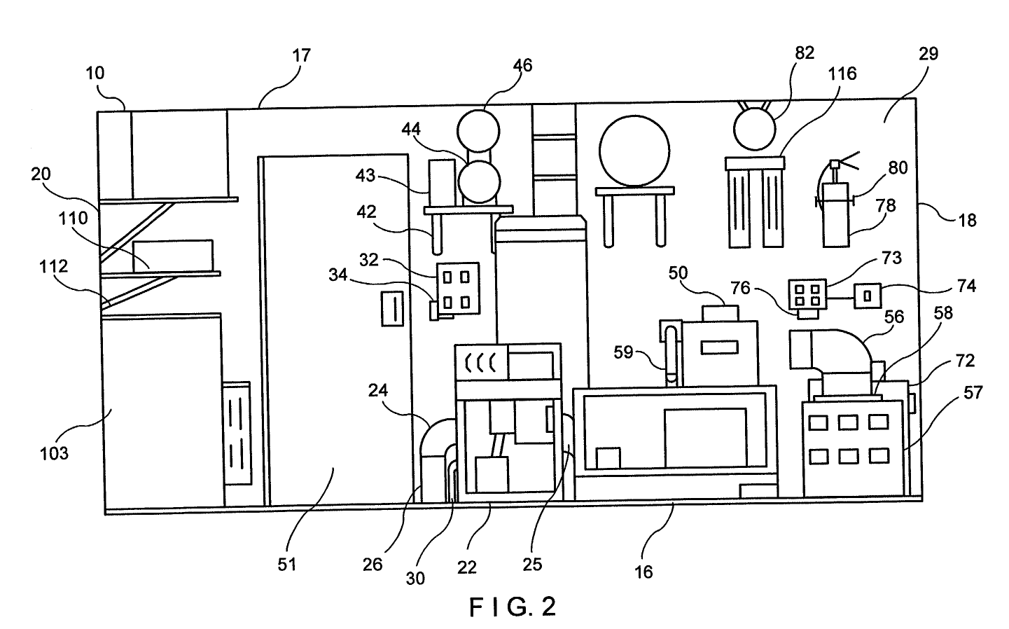

FIG. 2 is a sectional view depicting equipment placement on the interior wall of trailer 10 looking outward from the center-line of the trailer. The view is framed by trailer top 17, rear opening 18, floor 16, and front wall 20.

The power support for trailer 10 and the vehicle wash structure is provided by generator 22. A typical generator used would be a twenty-horsepower generator; however, a wide range of equivalents known to those skilled in the art may be used. Generator 22 is able to provide 13,000 watts of power to all electrical equipment within trailer 10 and that equipment used within the vehicle wash structure. Generator 22 has a ten-gallon gasoline carrying capacity.

Directing air flow at generator 22 are air induction elbows 24,25. Attached piping 26 (shown for elbow 24) penetrates floor 16 providing the ambient air needed for cooling and operation of generator 22. Closer to trailer wall 29 and mechanically coupled to generator 22 is heat-insulated exhaust elbow 30, which also penetrates trailer floor 16. Before passing to the outside air, exhaust gas from elbow 30 passes through a catalytic converter muffler system (not shown).

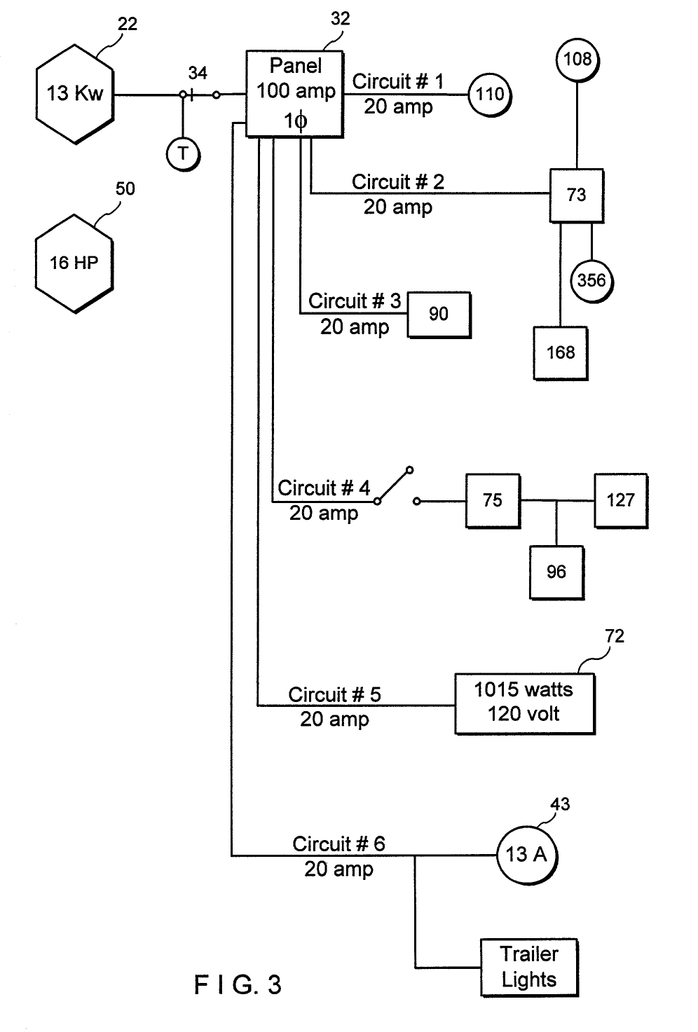

FIG. 3 depicts the power distribution from generator 22 in an electrical schematic with individual equipment identified to correspond with Figures identifying the location of the equipment.

As shown in FIG. 2, power produced by generator 22 is switched to other equipment in trailer 10 through circuit breaker box 32. Heat sensor 34 mounted on and electrically attached to circuit breaker box 32 is one component of the trailer's multi-layered fire suppression system. If the temperature rises above 150° F. within trailer 10, heat sensor 34 will automatically shut down the power at circuit breaker box 32.

Located on mounting cradle 42 above circuit breaker box 32 and welded to trailer wall 29 is compressor 43. Along with the trailer lights (not shown), compressor 43 is electrically supplied by a 20-amp circuit from circuit breaker box 32. Compressor 43 plugs into the 20-amp circuit. Compressor 43 is a 110 V, 13-amp device.

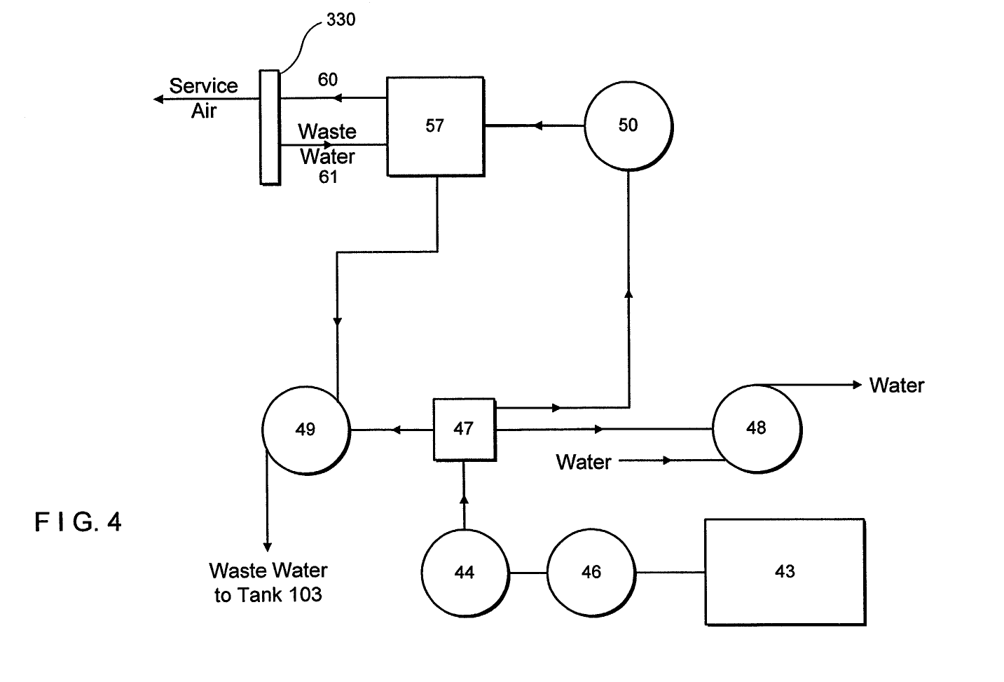

Compressor 43 provides compressed air to equipment throughout trailer 10 and to the vehicle wash structure. Compressed air available for use is piped to receivers 44, 46 where the air is stored for future use and released to major equipment by air regulator 47, shown in FIG. 4. FIG. 4 depicts the compressed air distribution system to major equipment such as universal transfer pump 48, grey water pump 49, and auxiliary air tank 50.

As shown in FIG. 2, compressor 43, circuit breaker box 32, and generator 22 are located near trailer side door 51 in order to provide centralized access to these components while also allowing emergency egress through door 51.

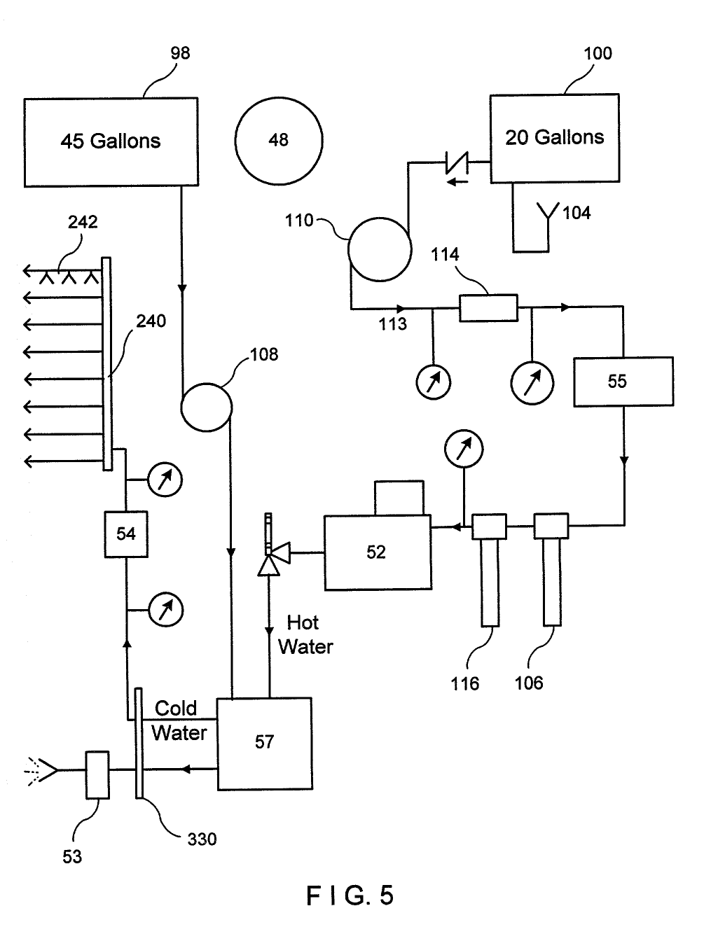

To the rear of generator 22 is power wash and steam generator 52 which provides a power wash supply to hand-held sprayers and nozzles within the vehicle wash structure. Powered by a sixteen-horsepower engine, the power wash generator 52 is able to provide 3000 psi to two or more hand-held sprayers 53 that are used in the vehicle wash structure. FIG. 5 depicts the water system of the vehicle wash including connections to major equipment and including fittings such as the manifold foot pedal 54 and pressure reserve tank 55.

Similar to generator 22, cooling air is provided by an air induction elbow 56. In order to conserve space in the rear of trailer 10, air induction elbow 56 attaches at hollow transition box 57 by way of air intake fan 58. Air intake fan 58 pressurizes and increases the volume of cooling air to steam generator 52. Trailer floor 16 is sectionally cut beneath transition box 57 in order to provide outside air for the intake of fan 58. Exhaust from power wash generator 52 is vented through exhaust piping 59 penetrating floor 16 and exiting to the outside air through a catalytic converter muffler system (not shown).

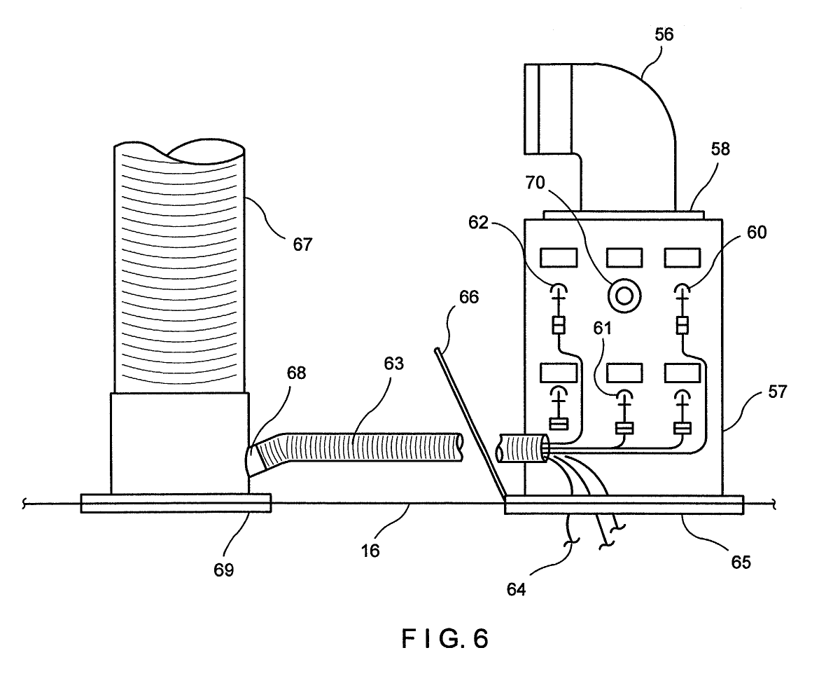

Transition box 57, detailed in FIG. 6, provides a hose connection for compressed air 60, waste water return 61, and air vacuum 62. System tubing from transition box 57 enters flex hose 63 along with electrical wiring 64. Electrical wiring 64 enters flex hose 63 by way of access port 65. Access port 65 penetrates floor 16 and is provided with hinged closure plate 66 which is closed during operation. Flex hose 63 enters utility hose 67 through hose fitting 68. In operation, utility hose 67 via umbilical duct 69 provides systems such as liquid and air supplies to and from the vehicle wash structure.

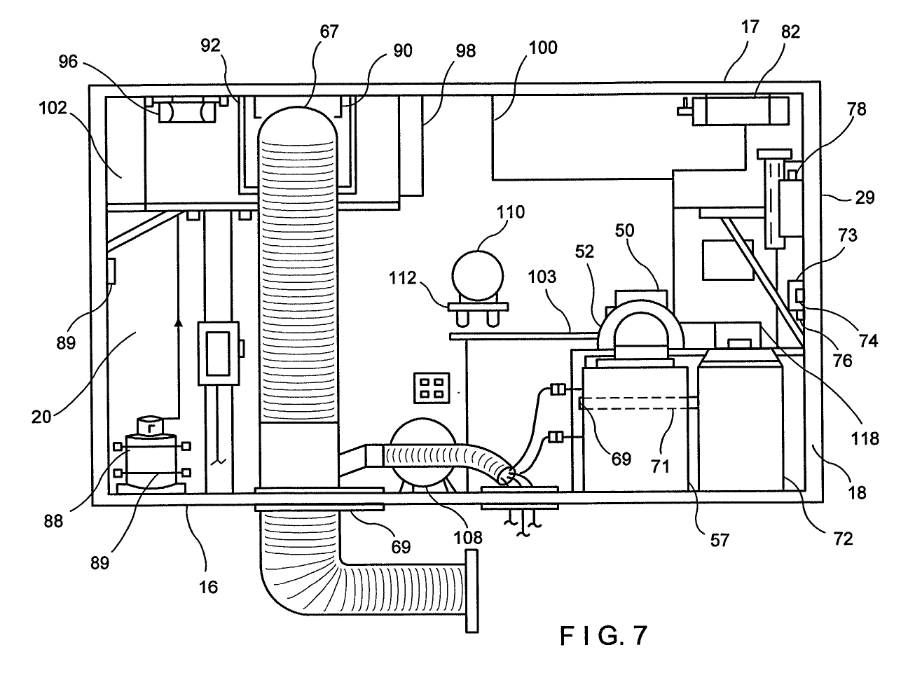

Vacuum hose connection 70 is mechanically connected to tubing 71, shown in FIG. 7. As a space saving feature, tubing 71 runs through transition box 57 to connect with vacuum 72. As shown in FIG. 3, vacuum 72 is preferably a plug-in, 1015 watt, 120-volt device; however, suitable alternatives may be used. Vacuum 72 is electrically supplied by a 20-amp circuit from circuit breaker box 32. Vacuum 72, along with other equipment, can be plugged into four-outlet, 20-amp, receptacle 73, shown in FIG. 7. Power to receptacle 73 can be shut off remotely at switch 74. Switch 74 is easily accessible through rear opening 18 of trailer 10.

As shown in FIG. 2, receptacle 73 is also electrically coupled to a receiver 76. Another receptacle 75 in trailer 10 is also provided with a receiver for remote operation. Both receivers allow remote control from the vehicle wash structure of power supplied by the receptacles.

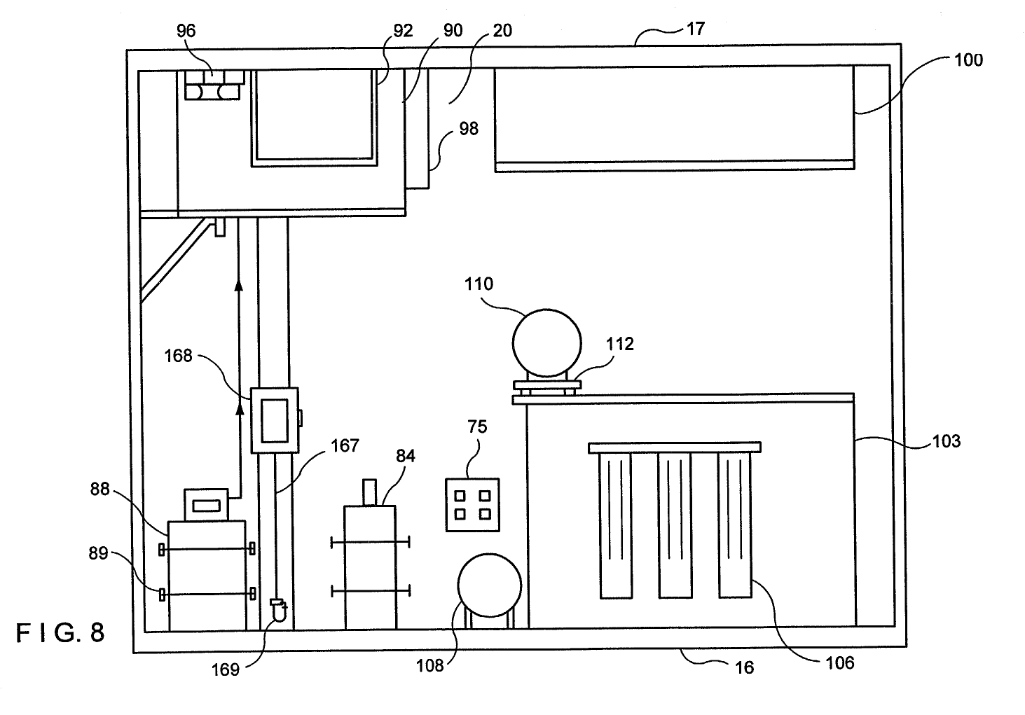

Another layer of the fire suppression system located near switch 74 is portable ABC-rated extinguisher 78 attached to trailer wall 29 by removable clips 80 and located near rear opening 18 for easy access from outside trailer 10. Additional fire protection is provided by a Halon 1211 heat-activated extinguisher. The heat-activated extinguisher 82 is shown; however, suitable substitutes may be used. Heat-activated extinguisher 82, which may be bracketed to the trailer top 17 or wall 29, releases nontoxic Halon 1301 gas when the temperature in trailer 10 exceeds 1750° F. Halon 1301 gas has an advantage over other fire suppression chemicals in that it minimally damages equipment. An identical heat-activated extinguisher 84, which provides fire suppression to propane tank 88, is shown in FIG. 8 on forward trailer wall 20. The combined capacity for extinguishers 82, 84 is 1500 cubic feet of Halon. Heat-activated extinguisher 84 in FIG. 8 is located to be near propane tank 88.

Propane tank 88, with a capacity of 20 lbs. of propane fuel, supplies propane furnace 90. Propane tank 88 is attached by safety bracketing 89 to forward trailer wall 20. Propane furnace 90 is an air induction forced hot air furnace. Hot air is supplied through heat duct 92 and onto the vehicle wash structure through utility hose 67. A remote heat source such as propane furnace 90 allows the vehicle wash structure to be heated without any electrical components near the structure. Temperature is controlled by a thermostat within trailer 10. Propane furnace 90 is electrically supplied by a 20 amp circuit (shown in FIG. 3).

Providing cross-ventilation and resultant cooling for trailer 10 are four cylinder fan units 96. Cylinder fan units 96, run alongside duct 92 and exhaust to the outside air through open sections in trailer top 17. Cylinder fan units 96 are electrically supplied by plugging into receptacle 75 (shown in FIG. 3).

Water for the vehicle wash apparatus is supplied by a forty-five gallon tank 98 and a twenty gallon tank 100. Foundations for both tanks are welded or mechanically attached to the trailer front wall 20 and/or to trailer top 17. Tributary tank 103 is a fifty-five gallon tank with a foundation on floor 16. A fill connection 104 is provided for attachment to outside water sources, shown in FIG. 4.

As shown in FIG. 8, water used in the vehicle wash structure is filtered through five-micron filters 106 bracketed to tributary tank 103. Tank 98 provides water directly to the vehicle wash structure by way of jet pump 108, foundated on floor 16 and plugged into outlet 73 (depicted in FIG. 3).

Tank 100 of FIG. 8 provides water to power wash generator 52 by way of jet pump 110 which has a foundation 112 on trailer front wall 20 and is hard-wired to panel 32 (shown in FIG. 3).

As shown in FIG. 4, downstream from jet pump 110 and connected to supply piping 113 is electronic regulator valve 114, which is used is used to control the water pressure in supply piping 113.

As shown in FIG. 2, before entering power wash generator 52, the water is filtered to one micron at canister filter assembly 116, mechanically mounted on trailer wall 29. From canister filter assembly 116 the water enters a reservoir (not shown) from which power wash generator 52 draws its supply. Depicted in FIG. 7, power wash generator 52 has an integral pump 118 which provides a constant pressure to the vehicle wash structure.

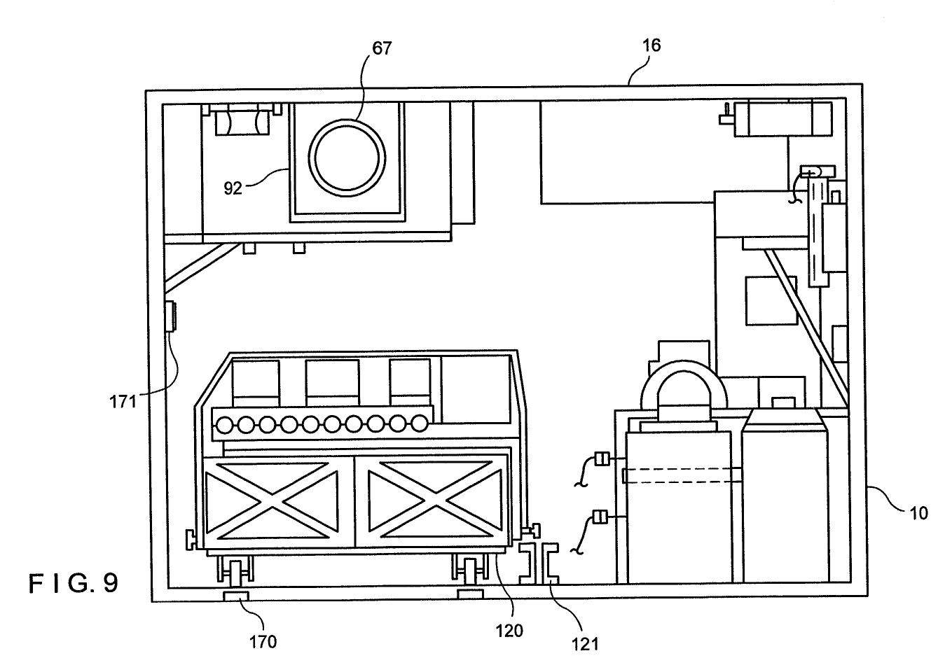

FIG. 9 depicts the stowage of containment cart 120 and ramps 121 when trailer 10 is in transport and when the vehicle wash apparatus is not in use. To allow for needed space, utility hose 67 is stowed in ducting 92.

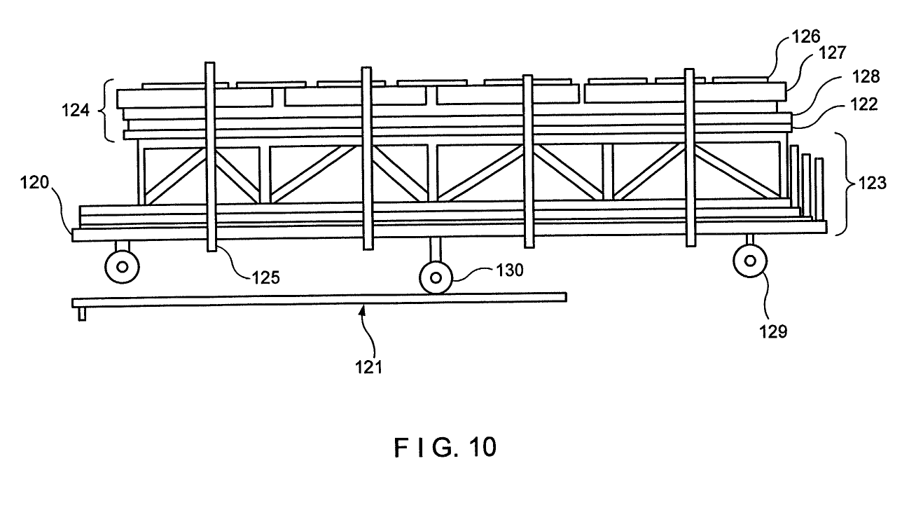

Loaded structure containment cart 120, depicted in FIG. 10, has a two-stage loading configuration with a loading bracket 122 separating a lower area 123 and an upper area 124. Equipment and rigging on cart 120 is secured for transport by nylon straps 125. Secured to upper area 124 are wash buckets 126, water-proof lighting fixtures 127, and vehicle wash structure system piping 128. Secured to lower area 123 is structural aluminum scaffolding. Because of the stowage requirements of the scaffolding, extra available space in lower area 123 can be used to stow buffer machines, a ladder, hoses, towel dispensers, environmentally safe cleaning products, a suction pump, and structure erection tools. Also contained in the available space around the scaffolding are all of the canvasses and non-scaffolding pieces required, including the structure side canvass, roof canvass, roller canvasses, containment mat, and solid corners.

Containment cart 120 is mechanically attached to six rollers. Forward and rear rollers 129 touch the surface or ramp 121 when central rollers 130, which are vertically longer than forward and rear rollers 129, are pivoted in either direction. By using the pivoting leverage of central rollers 130, containment cart 120 is able to be moved by one operator when loaded.

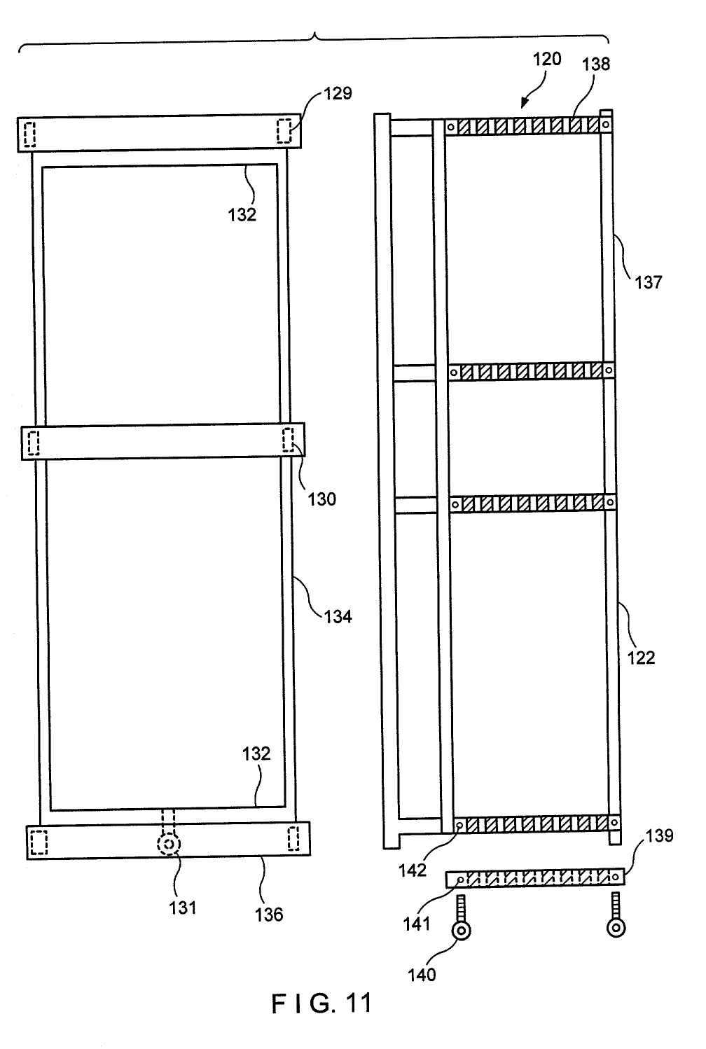

FIG. 11 depicts containment cart 120 unloaded. Eyelet bolt 131 is threadedly coupled to crossbar 132. Crossbars 132 are welded to longitudinal flatbars 134. Resting on and welded to crossbars 132 and longitudinal flatbars 134 are loading mounts 136. Loading mounts 136 provide an exposure area to transmit force evenly to the structure of cart 120. On the outer edges and on the underside of mounts 136 are mechanically attached rollers 129, 130.

Loading bracket 122 is shown as a configuration of welded aluminum members 137 placed to provide additional strength for loading upper area 124. Recesses 138, shown as shaded areas, are machined into the topside of members 137 allowing secure stowage of spray system piping. With spray system piping placed in recesses 138, the machined underside of bar 139 is threadedly secured by eyelet bolts 140 into apertures 141, 142. There are four bars 139 with corresponding eyelet bolts 140.

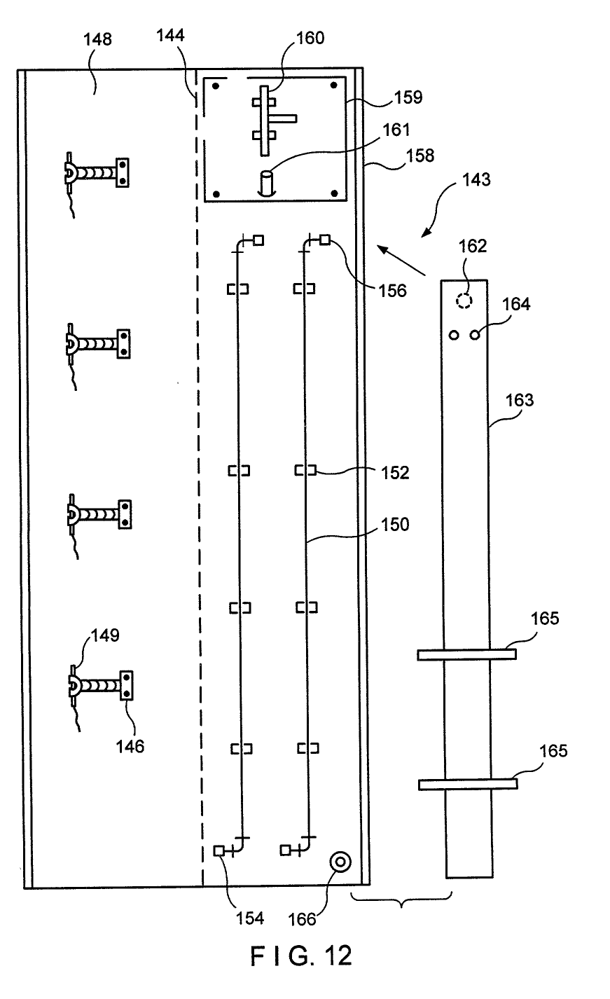

FIG. 12 depicts a solid corner 143 used as one of four corners in the assemblage of the vehicle wash structure. For this figure, corner 143 is flattened along interior edge 144 in order to depict components used within the vehicle wash structure. Four spring-tensioned grapples 146 are affixed to interior wall 148. Grapples 146 attach to reinforced eyelets on the side structure covering canvasses by means of pins 149.

In order to facilitate an overhead wash system, fixed sections of pipe 150 are secured by brackets 152 to wall 148. At the lower end of pipe 150 are hose couplings 154. Hose couplings 154 are used for attachment to water supply hoses from trailer 10 which run inside of flex hose 63. At the upper end of pipe 150 are couplings 156 used for attachment of the upper spray piping sections. Formed within one longitudinal edge of corner 143 is track 158 used as a guide for roller canvasses that are placed on the ends of the vehicle wash structure. A roller plate 159 with roller support 160 is mechanically affixed to corner 143 during vehicle wash structure assembly. Roller support 160 secures the roller canvasses and is used in operation with track 158. Equipment beam stud 161 is provided to secure with recess 162 of the underside of equipment beam 163. On the front side of equipment beam 163 are parallel recesses 164 provided as an attachment point for stud mounting equipment such as towel dispensers. Equipment beam 163 is also slotted for equipment panels 165. Equipment panels 165 can support items such as wash buckets 126. Also provided on corners 143 is quick-disconnect 166, an attachment point for hand-held spray guns 53.

To set up the vehicle wash structure, trailer 10 is moved to a designated wash site. At the site, structure containment cart 120 is winched out of the trailer 10 using wire rope 167 provided with winch 168 (shown in FIG. 8). Hook 169 should be properly secured to eyelet 131 of containment cart 120 (shown in FIG. 11). Ramps 121 are removed from trailer 10 and hooked into recessed attachment points 170 (shown in FIG. 9). Recessed attachment points 170 are spaced apart to align with the rollerbase of cart 120. Using remote winch control 171, cart 120 is pulled out of trailer 10 by an operator while restraining movement with wire cable tension. The wire cable tension allows removal of cart 120 without strain on the operator and without possible damage to cart 120 caused by quick removal.

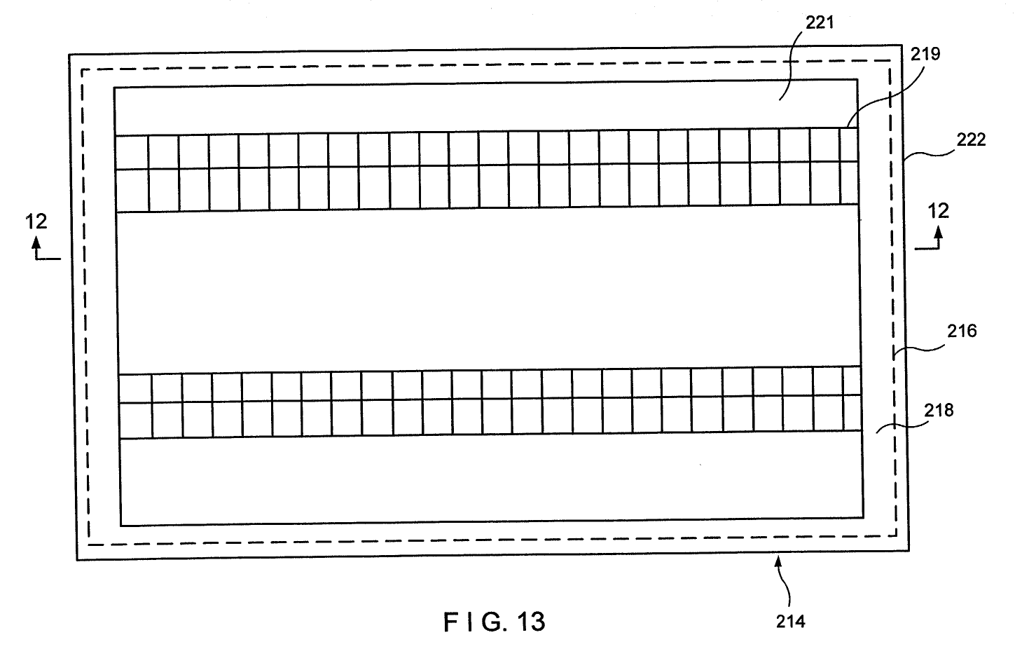

Floor containment mat 214 is removed from cart 120, unrolled, oriented and placed on a surface, where the vehicle wash apparatus will be assembled. FIG. 13 is a plan view of the setting of containment mat 214. Containment mat 214 should typically be a fire retardant reinforced membrane; however, suitable alternatives may be used. Containment mat 214 lays upon structural channel 216. The flattened top surface area 218 of channel 216 is in contact with the underside of containment mat 214, thus creating a berm inside the perimeter of containment mat 214. At this point or at a later point during assembly, rubber water-collecting tracks 219 can be placed on containment mat 214. Tracks 219 isolate any residual liquid dripping from the vehicle being washed and prevent residual liquids from being tracked outside of the structure.

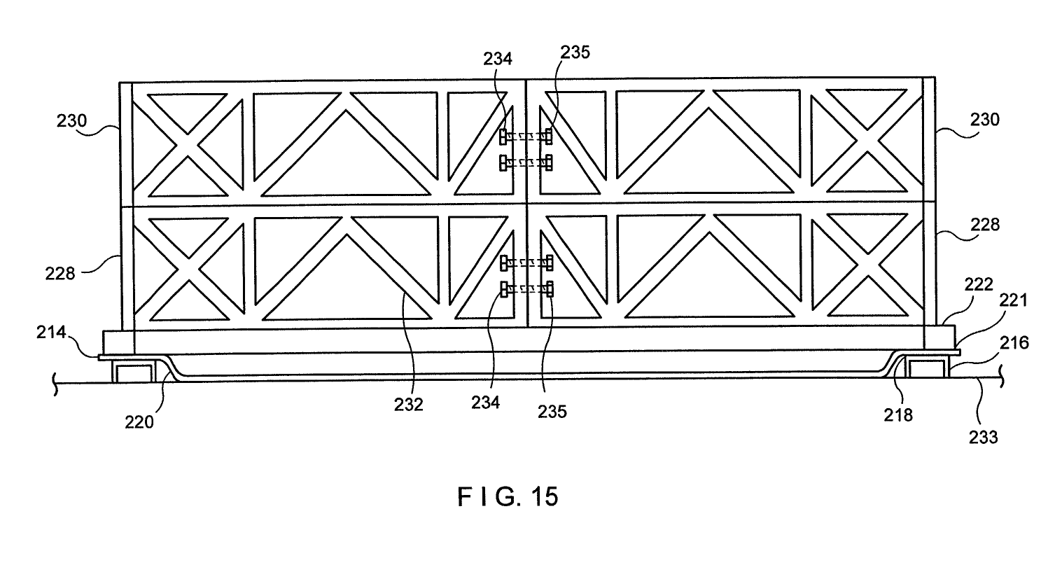

The mid-area created in containment mat 214 is recessed in relation to berm (220, shown in FIG. 15) allowing pooling of waste-water after washing which is to be pumped back to the treatment system in trailer 10. In vertical alignment with structural channel 216 and resting on the operational surface 221 of containment mat 214 are aluminum foundation sections 222. Foundation sections 222 maintain the positioning of containment mat 214 while providing a foundation for the building elements of the vehicle wash structure.

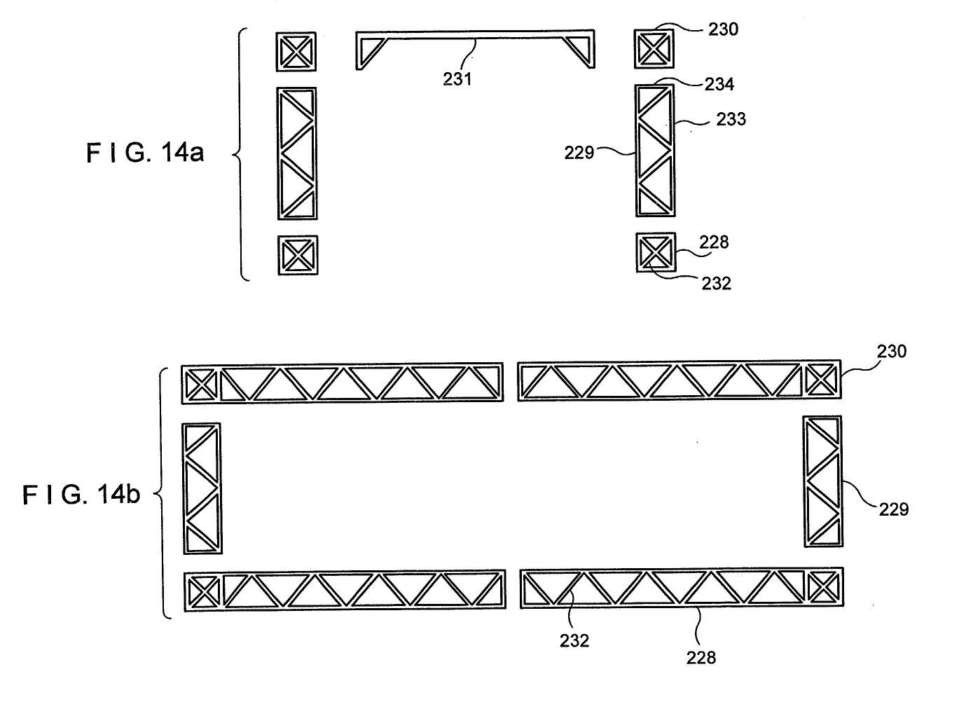

FIG. 14 depicts the aluminum structural components of the vehicle wash structure positioned for assembly. View A is an end view, depicting bottom cords 228, leg posts 229, top cords 230, and a top connection member 231. Bottom cord 228 is shaped as a 90° angle with square end units that have a height and width of approximately 16.5 inches. Additional strengthening of bottom cord 228 is provided by numerous cross-members 232.

Legpost 229 is shaped as a 90° angle and is sized to accommodate corner 143 (shown in FIG. 12). In FIG. 14, edge 233 is the centerline of the angle of legpost 229 with members 234 extending approximately 16.5 inches and 900 apart from each other. Legpost 229 has a top-to-bottom length of approximately 58.5 inches. Top cord 230 is identical in construction to bottom cord 228, except for attachment areas to connection member 231. Connection member 231 has a depth to accommodate attachment to top cord 230 and a width of approximately 108 inches, sized to accommodate the width of most vehicles.

View B is a side view of the assemblage for the vehicle wash structure depicting bottom cords 228, leg posts 239, and top cords 230. Bottom and top cords 228, 230 have a height of approximately 16.5 inches and a length from end-to-end of approximately 143.75 inches.

FIG. 15 is a section view looking from the mid-area of the containment mat 214 to its perimeter, depicting the installation of bottom cords 228 and top cords 230. In reference to this figure and subsequent figures, bottom cords 228 and top cords 230 have additional cross supports; however, the amount of supports shown was lessened for this figure and subsequent figures for a more accurate depiction of additional items of the assemblies. Bottom cord 228 rests on foundation section 222 shown with containment mat 214 resting on surface 233. After placement of the bottom cords 228, bottom cords 223 are secured to each other by bolts 234 and wingnuts 235 at the mid-longitudinal point of the vehicle wash structure. Top cords 230 are then placed on bottom cord 228 but are not secured to bottom cord 228. Top cords 236 are also attached by bolts 234 and wingnuts 235.

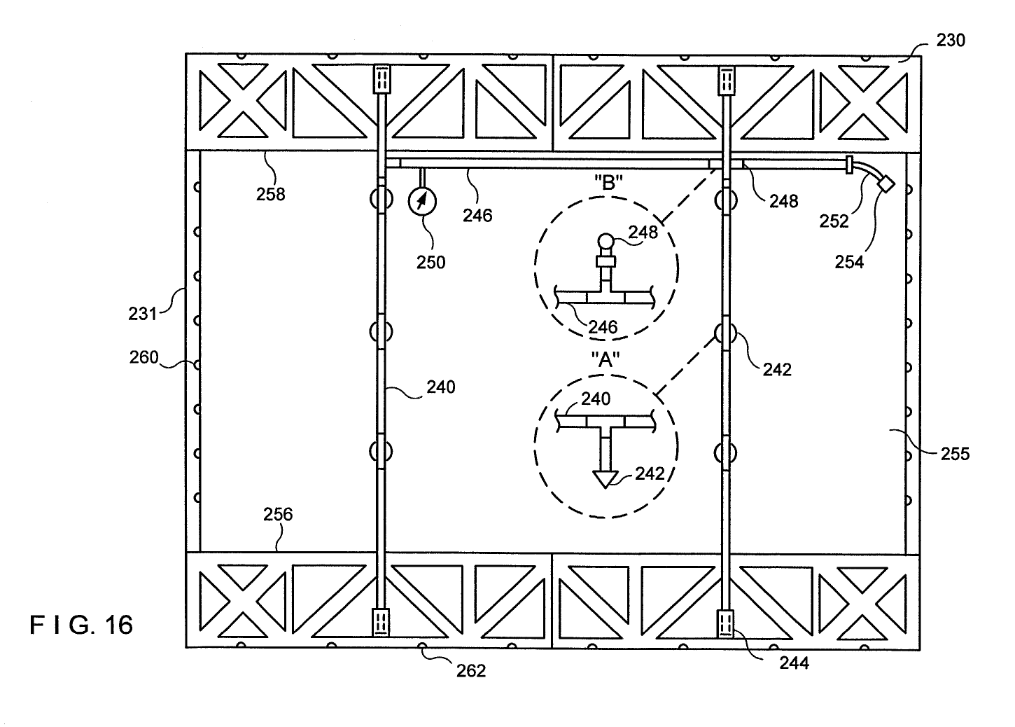

With top cord 230 resting on bottom cord 228, overhead spray sections 240 are placed on the top cord 230, as shown in FIG. 16. Two overhead spray sections 240 are shown; however, the vehicle wash structure supports ten sections with three nozzles 242 per section; the number of spray sections and nozzles can be increased or decreased depending on coverage preferences. Nozzles 242 face down and towards the centerline of the vehicle wash structure, in order to provide adequate coverage of the vehicle being washed. Magnified view “A” shows the arrangement of nozzle 242 in relation to spray section 240.

Welded to the top area of top cords 230 are channel pieces 244. Channel pieces 244 are positioned with the recessed area of the piece facing containment mat 214. Installed, spray sections 240 run over top cords 230 and rests in the recessed area of channel pieces 244.

Water is supplied to spray sections 240 by feeder main 246. Feeder main 246 attaches to spray sections 240 by quick-release couplings 248 shown in magnified view “B”. At the distal end of feeder main 246, a pressure gauge 250 is provided to assure that adequate water pressure is supplied to the spray section furthest from the supply. At the proximal end of the feeder main, hose 252 and fitting 254 are provided for connection to the water supply system.

After installation of spray section 240, a summer canvass or winter canvass 255 is placed over the vehicle wash structure including all spray system piping. Summer or winter canvass 255 should typically be made from awning fabric; however, a wide range of equivalents may be available known to those ordinarily skilled in the art. Canvass 255 would cover the longitudinal area between connection members 231 and the area between top cord edges 256, 258, attaching with tie-wraps to connection members 231 at apertures 260. This arrangement allows venting through top cords 230. A winter canvass would add to the area covered by also attaching at apertures 262 on top cords 230.

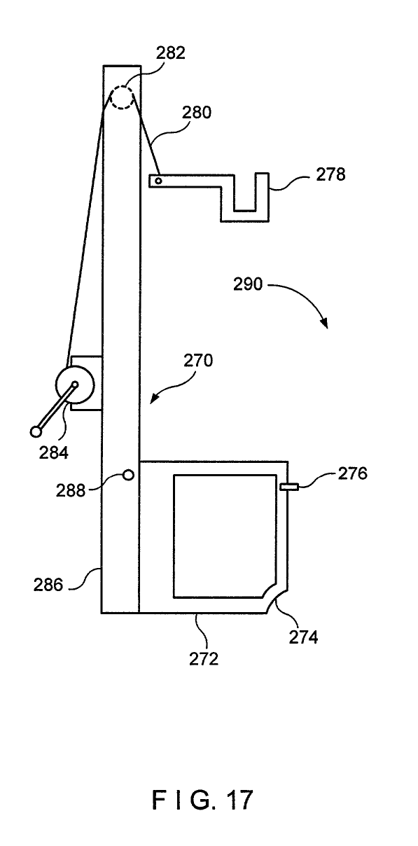

Jack 270, shown in detail in FIG. 17, comprises a bottom transom section 272 which presses bottom cord 228 at curved area 274 and attaches at clip 276. Hook 278 raises the underside of connector member 231 with the assistance of tensioned wire rope 280. Wire rope 280 is moved over pulley 282 by an operator using crank 284, with crank 284 foundated on aluminum stanchion 286. Pivot point 288 allows stanchion 286 to pivot in direction 290 when the top section of the vehicle wash structure is being elevated.

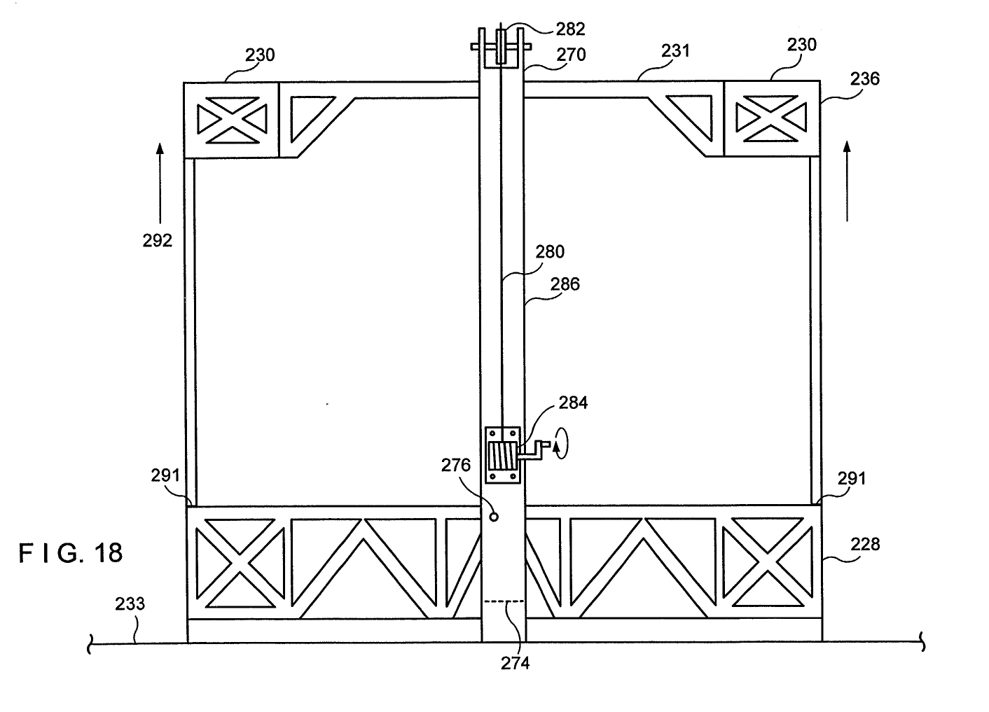

FIG. 18 depicts the placement of jack 270 placement from the front end of the vehicle wash structure looking toward top cords 230 angled relative to surface 233. To elevate top cords 230, connection member 231 is jacked up at one end by jack 270 pivoting at the other end 291 shown by direction arrows 292.

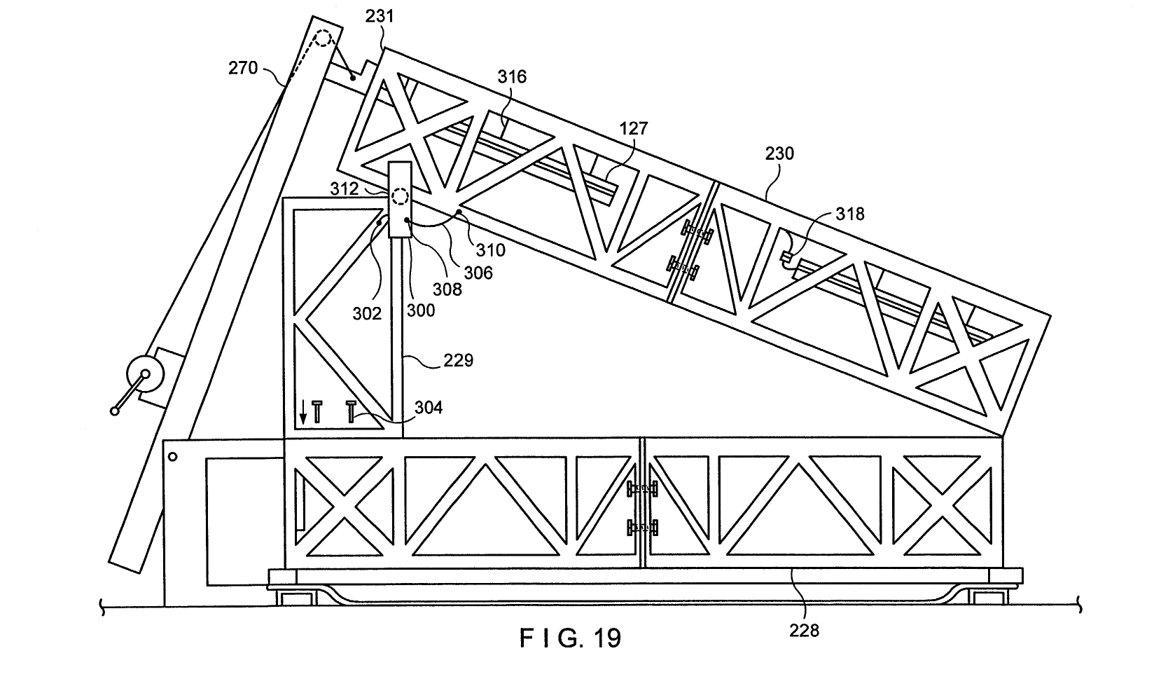

In FIG. 19, top cord 230 is elevated to allow installation of legpost 229. Caster 300 is secured to the two end legposts 229 with wingnuts 302. Legposts 229 are placed on bottom cords 228, and bolts 304 are dropped in apertures in bottom cords 228 to secure legposts 229. Casters 300 are secured to both top cords 230 by wire 306 and cotter pins 308, 310. Connection member 231 is pulled slightly by jack 270 to ensure adequate resting of top cords 230 on casters 312. With one-half of the vehicle wash structure elevated, lighting fixtures 127 are installed. Lighting fixtures 127 are provided with hooks 316 sized to fit into apertures drilled in both top cords 230. Lighting fixtures 127 are connected to “Underwriters Laboratory” water-proof connectors 318 and are electrically supplied by a 20-amp circuit (shown in FIG. 3). With lighting fixtures 127 installed, jack 270 is removed and set on the other end of the vehicle wash structure. Jacking top cords 230 and installation of legposts 229 is performed in the same manner described above, with the top cords 230 rolling forward on casters 300; positioned on legposts 229 and then bolted.

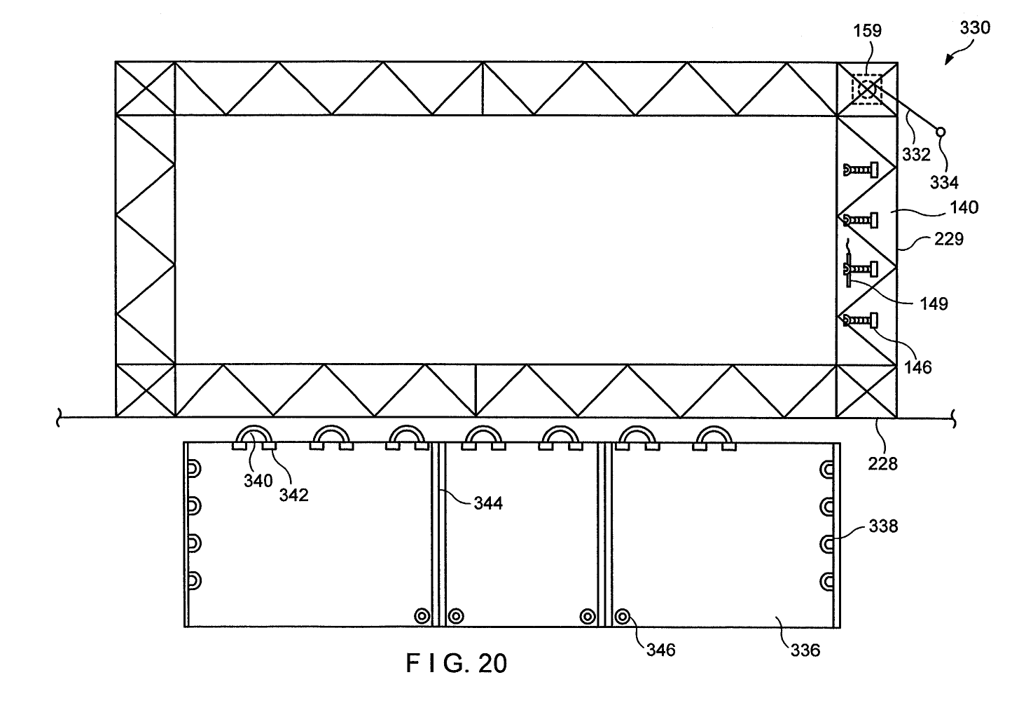

As shown in FIG. 20, solid corners 143 are now set in vehicle wash structure 330 and secured by wingnuts to leg posts 229, providing additional strength to the structure. Roller plate 159 is mechanically attached to corner 143 to allow installation of roller canvass 332. Roller guide 334 is sized to fit in track 158 and to allow easily roll-up of canvass 332 when staging a vehicle and roll-down for sealing vehicle wash structure 330.

Two side canvasses 336 provided with reinforced eyelets 338 are secured to spring grapples 146 with pin 149, four grapples 146 for each corner 143 with two corners per side. Spring grapples 146 provide flexibility of movement for canvass 336 under windy conditions. Overhead straps 340 are provided for attachment to the overhead spray system where straps 340 can be adjusted at hook points 342 on canvass 336. Side canvasses 336 may be a mesh-type surface for adequate ventilation in summer use, or the surface may have a more thickened weave to act as a heat insulator for winter use. Side canvass 336 is partially separated along seam 344. This separation allows entry of personnel or support systems where small eyelets 346 can be pulled away and secured to bottom cord 228 or to each other.

Using FIGS. 12 and 16 for guidance, feeder main 246 is secured to affixed piping 150 at coupling 156 on corner 143. Equipment beam 163 is secured to stud 163 at recess 162. Equipment panels 165 are inserted into slots in equipment beam 163 and stud securing items such as a towel dispenser are placed in parallel recess 164. Spray guns 53 are attached for supply at quick-disconnect 166.

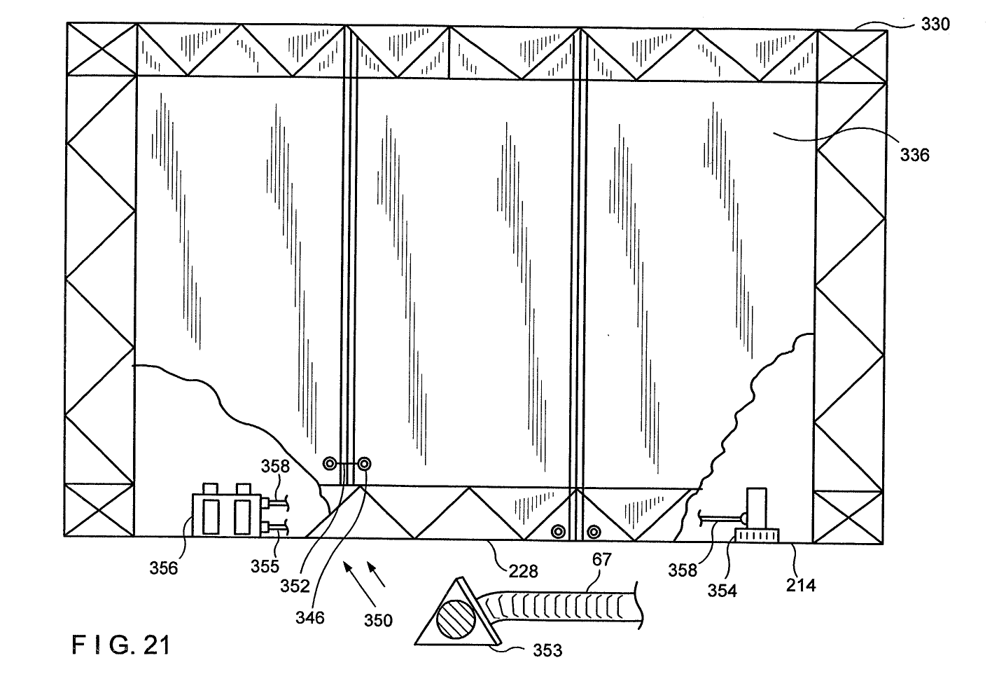

FIG. 21 is a side view of the vehicle wash structure showing side canvass 336 as a shaded area with a cutaway section to show placement of equipment within the structure. Water hoses, air lines, heating lines and air conditioning lines from equipment located in trailer 10 are brought out and connected to wash vehicle structure 330 through utility hose 67. Water for the wash system is connected to hose couplings 154 by a hose emitting from flex hose 63 which runs through utility hose 67. Utility hose 67 sizably fits in an area cleared by the pulling back of canvass 336 and between structural members of bottom cord 228 as indicated by direction arrows 350. As canvass 336 is pulled back, eyelets 346 are secured to each other or bottom cord 228 by tiewrap 352. In the final assembly step for the vehicle wash apparatus, triangular plate 353 connected to utility hose 67 is then placed between the structural members of bottom cord 228 and mechanically connected. Time for assemblage of the vehicle wash apparatus by two operators should be approximately 30 minutes.

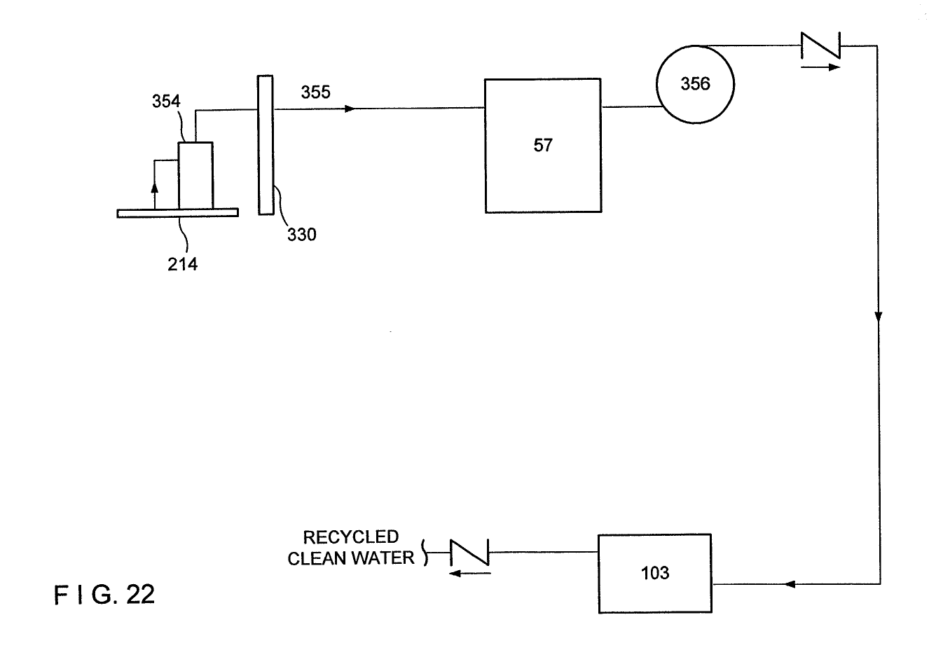

Wash water and run-off dispensed within vehicle wash structure 330 are captured by sump filter 354 within containment mat 214 on which the water will naturally gather from the natural draining topography of the parking area. As shown in FIG. 22, wash water is pumped back to trailer 10 through hose 355 and onto flex hose 63 contained in utility hose 67 for filtration processing by means of a double diaphragm air compression siphon sump pump 356 connected to sump filter 354 by hose 358. Sump pump 356, which can be located in or outside trailer 10, is preferably a one-third horsepower pump; however, suitable alternatives may be used. Sump pump 356 is a plug-in type pump electrically supplied by a 20-amp circuit, shown in FIG. 3.

Water returned to the trailer 10 is processed through a tributary tank system for filtration and re-use. Water processed through the tributary tank system may be used multiple times. Trailer 10 is now ready for full operation with a vehicle to be washed pulled in all access doors closed. With the access doors closed, the decibel level is reduced to operate within OSHA operating standards.

Washing of the vehicle is executed by means of hand-held wash guns 53, overhead foot control spray systems, and uniform straight-line hand washing with high nap virgin rinsed and clean detail clothes. Hand wax and polish is in the same straight-line uniform pattern to ensure that total coverage of the vehicle is addressed.

Interfacing of equipment between the trailer 10 and vehicle wash structure 330 is accomplished by hand-held remote control, and foot pedals 54. A supervisory operator will also handle and secure keys to the vehicle being washed while under digital camera surveillance. Trailer 10 provides power to all waterproof lights 127 and power connectors 318 within the structure. Water is dispensed upon the vehicle in the wash process by a high pressure atomization of the water to ensure water conservation. Using no more than 2 gallons of water per standard size vehicle allows rapid drying and fine detailing of the vehicle creating a short wash window time.

Roller canvasses 332 are opened and the vehicle is removed enabling the washing process to start for the next vehicle. The off-site wash period is approximately 7 hours with two end 30 minute set-up and breakdown periods for the structure. Wash periods may be longer if vehicle wash structure 330 is used as a semi-permanent structure. Upon the end of the wash period, containment mat 214 is cleaned and vacuumed so that vehicle wash structure 330 may be dismantled and loaded onto cart 120. Containment mat 214 and canvasses can be loaded within the dismantled structure onto containment cart 120 and secured by nylon straps 125 so that cart 120 can be winched back and secured within trailer 10.

Trailer 10 is then closed and secured for over-the-road travel to a homesite for subsequent replenishment of cleaning supplies and support systems. At the homesite, filter cartridges from filters 116 are removed and replaced by an experienced hauler.

Thus by the present invention its objects and advantages are realized and although preferred embodiments have been disclosed and described in detail herein, its scope should be determined by that of the appended claims.

We claim:

1. An apparatus for a mobile self-contained vehicle wash including:
a trailer;
a water source contained within said trailer;
a pump mechanically connected to supplied by said water source wherein said pump is located within said trailer;
a vehicle wash structure supplied by said pump whereby said vehicle wash structure in a disassembled form is contained within said trailer and whereby said wash structure is assembled for use as a vehicle wash outside of said trailer.

2. The apparatus of claim 1, wherein said trailer fully encloses an interior.

3. The apparatus of claim 1, further including a power generator located within said trailer, whereby said power generator is an independent power source.

4. The apparatus of claim 1, further including a heat sensor wherein said heat sensor shuts down power at a circuit breaker box within said trailer.

5. The apparatus of claim 1, further including a vacuum, whereby said vacuum supports a vacuuming operation within said vehicle wash structure.

6. The apparatus of claim 1, further including a power wash generator located in said trailer, whereby said power wash generator provides pressurized and high-heated water to said vehicle wash structure.

7. The apparatus of claim 6, further including a hand-held sprayer whereby said hand-held spray is supplied with water from said power wash generator.

8. The apparatus of claim 1 further including an air compressor, wherein said air compressor provides air to the vehicle wash structure.

9. The apparatus of claim 1, further including a transition box wherein said transition box provides a central connection point for compressed air, waste water return, and air vacuum traversing between said vehicle wash structure and said trailer.

10. The apparatus of claim 1, further including a flex hose wherein said flex hose provides umbilical support of necessary systems from said trailer to said vehicle wash structure.

11. The apparatus of claim 1, further including a remotely operated electrical receptacle wherein said electrical receptacle can be switched at a distance to different power modes.

12. The apparatus of claim 1, further including a heat source which provides heat for said trailer and said vehicle wash structure.

13. The apparatus of claim 12, further including a propane tank which provides fuel for said heat source.

14. The apparatus of claim 1, further including a tributary tank wherein said tributary tank holds waste water produced from said vehicle wash structure.

15. The apparatus of claim 14, further including a plurality of filters wherein said filters recycle waste water contained and drawn from said tributary tank.

16. The apparatus of claim 15, wherein said waste water is filtered to approximately three microns.

17. The apparatus of claim 1, further including an electronic regulator valve wherein said valve controls a water pressure of said water source.

18. The apparatus of claim 1, further including a containment cart whereby said containment cart is a storage area for said vehicle wash structure.

19. The apparatus of claim 18, wherein said containment cart provides additional storage for support equipment for said vehicle wash structure.

20. The apparatus of claim 19, wherein said containment cart further includes a pivoting movement structure.

21. The apparatus of claim 20, wherein said containment cart further includes a loading bracket machined for securing spray system piping.

22. The apparatus of claim 1, wherein said wash structure further includes corner pieces wherein said corner pieces provide attachment areas for a covering canvass.

23. The apparatus of claim 22, wherein said corner piece further provides support for wash piping of said vehicle wash structure.

24. The apparatus of claim 22, wherein said corner piece further includes attachment areas wash support equipment shelving.

25. The apparatus of claim 22, wherein said corner piece further includes a guide mechanism where said guide mechanism allows roller operation of end canvass closures of said vehicle wash structure.

26. A method of assembling a mobile self-contained vehicle wash, said method comprising the steps of
providing a trailer containing said mobile self-contained vehicle wash;
removing a vehicle wash structure from said trailer;
assembling said vehicle wash structure on a parking surface; and
connecting said vehicle wash structure to a pump contained within said trailer, thereby providing pressurized water to said wash structure.

27. The method of claim 26, wherein said vehicle wash structure is removed on a containment cart.

28. The method of claim 26, further including the step of setting a containment mat on the base of said vehicle wash structure wherein said containment mat collects residual liquid produced during vehicle wash operation.

29. The method of claim 26, further including the step of pumping residual liquid produced during a wash operation back to said trailer.

30. The method of claim 29, further including the step of treating said residual liquid for re-use within the vehicle wash structure.

31. The method of claim 26, further including the step of installing an overhead spray section wherein said spray section provides directional flow of wash fluid within said vehicle wash structure.

32. The method of claim 31, further including the step of monitoring a pressure within said spray section thereby ensuring adequate wash fluid coverage of said vehicle.

33. The method of claim 26, further including the step of positioning structural components of said vehicle wash structure using a jack.

34. The method of claim 33 wherein said jack comprises
a base;
a stanchion pivoting on said base;
a cranking device affixed to said stanchion;
wire rope wound on said cranking device wherein said cranking device lifts said structural components by wire tension;
a notched jacking plate mechanically secured to said wire rope wherein said jacking plate provides an attachment section between said jack and said structural components.

35. The method of claim 26, further including the step of providing solid corners within the wash structure wherein said corners provide system support conduits and additional structural support for said wash structure.

36. The method of claim 26, further including the step of covering said wash structure with canvass sections wherein said canvass sections isolate wash operations within said vehicle wash structure.

37. The method of claim 26, further including the step of installing roller canvass sections at the ends of said vehicle wash structure.

38. The method of claim 26, further including the step of providing heat to said vehicle wash structure.

39. The method of claim 26, further including the step of providing electrical power to said vehicle wash structure.

40. The method of claim 26, further including the step of providing compressed air to said vehicle wash structure.

41. A method of washing a vehicle using a mobile self-contained vehicle wash; said method comprising the steps of:
providing the mobile self-contained vehicle wash of claim 1;
soaking the vehicle with fluid supplied by fixed spray nozzles by remotely activating pumps within said trailer;
adjusting with a foot pedal an amount of said fluid dispensed by the spray nozzles;
applying a cleansing agent to said vehicle; and
rinsing the vehicle with fluid supplied by said spray nozzles.

42. The method of claim 41, wherein said soaking and application steps further include the high pressure atomized water of a hand-held sprayer.

43. The method of claim 41, including the further steps of:
capturing said fluid;
pumping said fluid to a tributary system within the trailer;
filtering said fluid, thereby making the fluid available for re-use within the vehicle wash.

44. The method of claim 41, further including the step of:
vacuuming the interior of the vehicle wherein said vacuum is remotely operated with the vehicle wash structure.

45. The method of claim 43, wherein said filtered fluid and residual effluence is held for future disposal.
